(19) United States
(12) Patent Application Publication
(10) Pub. No.: US 2014/0150083 A1
(43) Pub. Date: May 29, 2014

(54) VIRTUAL PRIVATE NETWORK SOCKET

(71) Applicants: Francis DINHA, Dublin, CA (US); Elfredy Cadapan, Pleasanton, CA (US)

(72) Inventors: Francis DINHA, Dublin, CA (US); Elfredy Cadapan, Pleasanton, CA (US)

(21) Appl. No.: 14/088,379

(22) Filed: Nov. 23, 2013

Related U.S. Application Data
(60) Provisional application No. 61/730,469, filed on Nov. 27, 2012.

(51) Int. Cl. H04L 29/06

(52) U.S. Cl. CPC H04L 63/0272
USPC 726/15

(57) ABSTRACT

A system and method for a virtual private network (VPN) wherein some embodiments includes creating complementary stack layers on both a client and a server device. An application operating through the VPN establishes a socket level protocol for operation of the VPN such that an application communicates with a client socket VPN layer which, in turn, is coupled to a server VPN layer. Data is encapsulated in a private tunnel. Certain embodiments may provide for VPN sockets for each application allowing concurrent VPNs to operate on a single device.

### PRIORITY

This application claims the benefit of co-pending provisional patent application 61/730,469 by Francis Dinha, filed Nov. 27, 2012 entitled “Virtual Private Network Socket.”.

### BACKGROUND

Currently the public Internet, designed to provide access to Internet resources and services, provides very little security against man-in-the-middle attacks. Also lacking is substantial privacy for the exchange of sensitive information, and protection against malicious encounters. The open design of the Internet allows for a wide range of communication, but that open design also thwarts attempts to provide reliable security.

One means of secure communications through the Internet is through the use of a virtual private network (VPN). This private network interconnects remote networks through public communication infrastructures such as the Internet. VPNs provide security through tunneling protocols and security procedures using encryption. Conventional uses of VPNs include securely connecting the branch offices of a bank to a head office network over the Internet. A VPN can also be used to interconnect two similar-type networks over a dissimilar middle network for example, thus alleviating interconnectivity issues.

In general there are two major types of VPNs: remote-access VPNs and Site-to-site VPNs. Remote-access VPNs let individual users connect to a remote network. Site-to-site VPNs allow inter-connection of networks of multiple. VPNs reduce costs by eliminating the need for dedicated leased lines between networks, because they use existing, lower cost, infrastructure to connect networks while, at the same time, adding a layer of security.

VPNs conventionally require remote users to be authenticated and make use of encryption techniques to prevent disclosure of private information to unauthorized parties. VPN users are able to access functionalities across networks, such as remote access to resources like files, printers, databases or internal websites in a secure manner.

Once connected, a VPN creates a so-called tunnel through the Internet. Tunnel endpoints generally authenticate before secure VPN tunnels can be established to ensure a proper tunnel exists. VPNs may use passwords, biometrics, two-factor authentication or other cryptographic methods to secure the tunnel. Network-to-network tunnels may also use digital certificates to allow the tunnel to establish automatically and without intervention from the user.

### SUMMARY

Disclosed herein is a system and method for a virtual private network (VPN) that includes creating complementary stack layers on both a client and a server device. An application operating through the VPN establishes a socket level protocol for operation of the VPN such that an application communicates with a client socket VPN layer which, in turn is coupled to a server VPN layer. Data is encapsulated in a private tunnel. Certain embodiments may provide for VPN sockets for each application allowing concurrent VPNs to operate on a single device.

### BRIEF DESCRIPTION OF THE DRAWINGS

FIG. 1 shows a functional block diagram of a client server system that may be employed for some embodiments according to the current disclosure.

FIG. 2 illustrates a method which may be employed in certain embodiments.

FIG. 3 depicts an embodiment of one possible implementation of a virtual private network socket.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### Lexicography

Read this application with the following terms and phrases in their most general form. The general meaning of each of these terms or phrases is illustrative, not in any way limiting.

The term “application programming interface” or “API” generally refers to a code-based specification intended to be used as an interface by software components to communicate with each other. An API may include specifications for routines, data structures, object classes, and variables.

The term “HTML Injection” generally refers to injecting HTML code into a web server's response to alter the content to the end user. This may also be known as cross site scripting.

The term “encapsulate” generally refers to a method of designing communication protocols in which logically separate functions in the network are abstracted from their underlying structures by inclusion or information hiding within higher level objects. Typically the more abstract layer is often called the upper layer protocol while the more specific layer is called the lower layer protocol.

The term “encryption” generally refers to the process of transforming information (referred to as plaintext) using an algorithm (called a cipher) to make it unreadable to anyone except those possessing special knowledge, usually referred to as a key. The result of the process is encrypted information (or ciphertext). The reverse process, making the encrypted information readable again, is generally referred to as decryption. The word encryption may also refer to the reverse process as well. For example, “software for encryption” often performs decryption.

The term “extension” and “browser extension” and the like generally refer to a computer program, applet or instructions that extend the functionality of a web browser in some way. Depending on the browser, the term may be distinct from similar terms such as plug-in or add-on.

The term “host machine” generally refers to a single processor-based machine that includes the elements of the system under discussion. However, this disclosure should not be read to limited a host machine in that manner when one having skill in the art will recognize that one or more of those elements may be performed remotely.

The word “Middleware” generally means computer software that connects software components or applications. The software consists of a set of enabling services that allow multiple processes running on one or more machines to interact across a network. Middleware conventionally provides for interoperability in support of complex, distributed applications. It often includes web servers, application servers, and similar tools that support application standards groups.

The term “Public IP Address” generally refers to a valid IP address that falls outside any of the IP address ranges reserved for private uses by Internet

The term “Socket” or “Network Socket” generally means an endpoint of an inter-process communication flow across a computer network. Conventionally, most communication between computers is based on the Internet Protocol; therefore most network sockets are Internet sockets. For purposes of this disclosure, the term “socket” may refer to an entity that is uniquely identified by the socket number, or the term “socket” may refer to a local socket address (i.e. a combination of an IP address and a port number).

The term “Socket API” generally refers to an application programming interface (API), which may be provided by the operating system. A Socket API allows application programs to control and use network sockets. Internet socket APIs are conventionally based on the Berkeley sockets standard.

The term “Socket Address” generally refers to the combination of an IP address and a port number. Based on the socket address, internet sockets deliver incoming data packets to the appropriate application process or thread.

The term “Socket VPN client layer” generally refers to a layer present at client side for use with one or more applications. It may contain code to function as a VPN client, as well as network libraries sufficient to allow it to emulate the transport/network layers of a stack. It may also emulate the stack when communicating to an application, as well as when setting up a VPN connection to a VPN server.

The term “Socket VPN server layer” generally refers to a layer present on an interface of a VPN server. It may execute network and port mapping functions, and receive incoming virtual streams from a Socket VPN client layer.

The terms “software as a service” or “SaaS” or “on-demand software” generally mean a software delivery model in which software and its associated data are hosted centrally such as on the Internet or cloud and accessed by users using a client. SaaS is a common delivery model for many business applications, including accounting, collaboration, customer relationship management (CRM), management information systems (MIS), enterprise resource planning (ERP), invoicing, human resource management (HRM), content management (CM) and service desk management.

The term “structured data” generally refers to data stored in a meaningful fashion such that a processor may be instructed to access the data. Examples include but are not limited to databases, relational databases, text files, XML file and the like.

The term “TCP/IP stack” and “Protocol stack” generally refers to a set of networking protocols used for communicating over a network or a set of network protocol layers that work together. The OSI Reference Model that defines multiple protocol layers is often called a stack, as is the set of TCP/IP protocols that define communication over the internet. The term stack may also refer to the actual software that processes the protocols. For example and without limitation, programmers sometimes refer to loading a stack, which means to load the software required to use a specific set of protocols.

The term “tunneling” generally refers to network protocol that encapsulates a different payload protocol. The use of tunneling may allow for carrying a payload over an incompatible delivery-network, or providing a secure path through an un-trusted network.

The terms “TUN” and “TAP” generally refer to virtual network kernel devices such as network devices that are supported entirely in software. TUN and TAP devices are different from ordinary network devices that are backed up by hardware network adapters. A TAP may simulate a link layer device and it operates with layer 2 packets such as Ethernet frames. A TUN may simulate a network layer device and it operates with layer 3 packets such as IP packets. Conventionally, TAP is used to create a network bridge, while TUN is used with routing.

The term “virtual machine” or “VM” generally refers to a self-contained operating environment that behaves as if it is a separate computer even though it is part of a separate computer or may be virtualized using resources form multiple computers.

The terms “virtual private network” and VPN generally refer to a private network that interconnects remote (and often geographically separate) networks and devices through primarily public communication infrastructures such as the Internet. VPNs provide security through tunneling protocols and security procedures such as encryption.

The term “VPN Server” generally refers to a server that establishes encrypted channels from point to point. In some embodiments both Socket VPN layers have to execute stack emulation to operate with VPN servers that handle VPN tunnels.

The acronym “XML” generally refers to the Extensible Markup Language. It is a general-purpose specification for creating custom markup languages. It is classified as an extensible language because it allows its users to define their own elements. Its primary purpose is to help information systems share structured data, particularly via the Internet, and it is used both to encode documents and to serialize data.

### System Elements

### Processing System

The methods and techniques described herein may be performed on a processor based device. The processor based device will generally comprise a processor attached to one or more memory devices or other tools for persisting data. These memory devices will be operable to provide machine-readable instructions to the processors and to store data, including data acquired from remote servers. The processor will also be coupled to various input/output (I/O) devices for receiving input from a user or another system and for providing an output to a user or another system. These I/O devices include human interaction devices such as keyboards, touch screens, displays and terminals as well as remote connected computer systems, modems, radio transmitters and handheld personal communication devices such as cellular phones, “smart phones” and digital assistants.

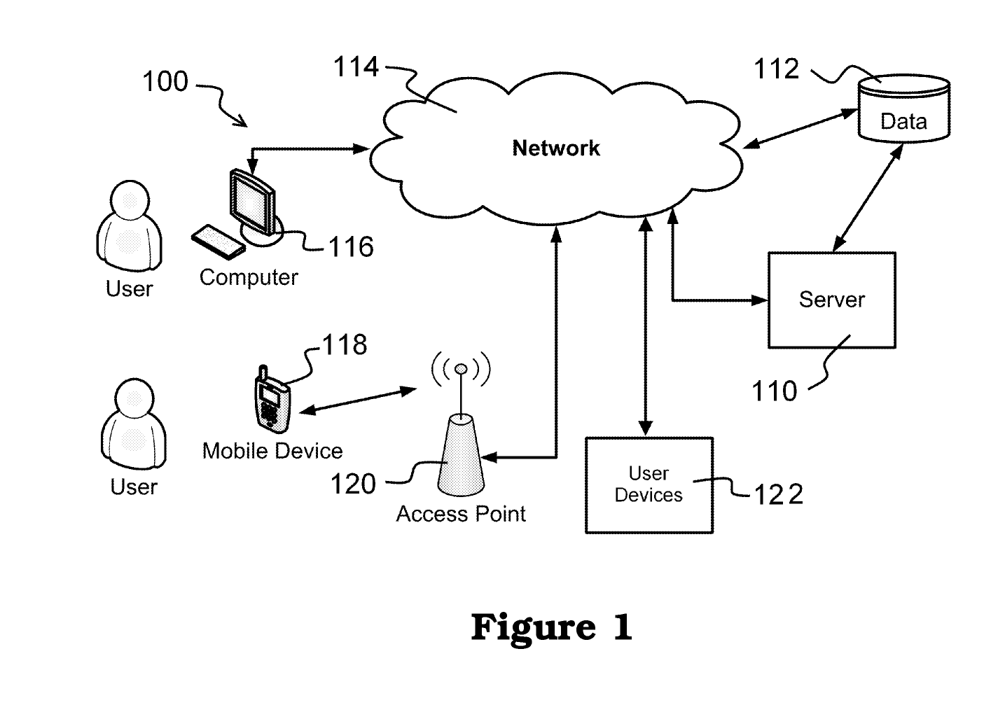

FIG. 1 shows a functional block diagram of a client server system 100 that may be employed for some embodiments according to the current disclosure. In the FIG. 1 a server 110 is coupled to one or more databases 112 and to a public network 114 such as the Internet. The network may include routers, hubs and other equipment to effectuate communications between all associated devices. A user accesses the server by a computer 116 communicably coupled to the network 114. The computer 116 may include a sound capture device such as a microphone (not shown). Alternatively the user may access the server 110 through the network 114 by using a smart device such as a telephone or PDA 118. The smart device 118 may connect to the server 110 through an access point 120 coupled to the network 114. The mobile device 118 includes a sound capture device such as a microphone.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

### VPN Security

VPNs conventionally require remote access to be authenticated and make use of encryption techniques to prevent disclosure of private information. VPNs provide security through established tunneling protocols and security procedures such as encryption. These security models may provide:
Confidentiality such that even if traffic is sniffed, an attacker would only see encrypted data which they cannot understand;
Allowing sender authentication to prevent unauthorized users from accessing the VPN, and
Message integrity to detect any instances tampering of transmitted messages.

Secure VPN protocols may also include one or more of the following:
Internet Protocol Security (“IPSec”). IPSec functions through encrypting and encapsulating an IP packet inside an IPSec packet. De-encapsulation happens at the end of the tunnel, where the original IP packet is decrypted and forwarded to its intended destination.
Transport Layer Security (SSL/TLS) can tunnel an entire network's traffic, as it does in the OpenVPN project, or secure an individual connection.
Datagram Transport Layer Security (DTLS), is used to solve the issues SSL/TLS has with tunneling over UDP.
Microsoft Point-to-Point Encryption (MPPE) for the Point-to-Point Tunneling Protocol.
Secure Socket Tunneling Protocol (SSTP), which tunnels Point-to-Point Protocol (PPP) or Layer 2 Tunneling Protocol traffic through an SSL 3.0 channel.
Secure Shell (SSH) VPN—SSH servers provide a limited number of concurrent tunnels and the VPN feature itself does not support personal authentication

### Private Tunnel

A private tunnel provides a framework for effectuating secure communications for the purpose of enterprises such as Application Providers, Service Providers, Private Businesses, and the like to utilize a private tunnel service. The establishment of a private tunnel between a client and an application/service provider may be for providing web services, specific applications, unified threat management (UTM), firewall, and other services through the private tunnel. The private tunnel includes a predetermined communication protocol, systems for providing and managing network addresses, and systems for providing and managing encryption certificates for authenticating associated resources. The private tunnel may employ conventional techniques such as those found in VPNs to maintain security. In operation each logical device on the private tunnel network has a unique address. In some embodiments a private tunnel can use existing addressing schema such as IPv4 or IPv6 as its internal addressing scheme. The address may be supplied to the device during an initialization step by a global address manager. Along with the address, each device may also receive a signed cryptographic certificate from the global address manager. In certain embodiments the cryptographic certificate may have a predetermined expiration time or may expire in response to certain usage limits.

### Socket VPN

A socket-based VPN may allow for VPN access for a single application, without affecting network traffic for any other applications on the same device. This obviates the need for a dedicated TUN/TAP virtual network interface adapter which may be required for certain VPN solutions.

In some embodiments a socket VPN layer is created. On the Application side, the Socket VPN layer may emulate the behavior of the standard IP socket library by providing methods for initiating and maintaining TCP and UDP sockets. On the VPN core side, it may use VPN methods to initiate a VPN connection and create a tunnel to a server, relaying any incoming/outgoing data from opened sockets to the VPN server over the device's existing default network adapter. For example and without limitation, only traffic to and from sockets opened with the socket VPN layer may be relayed through the VPN. All other applications that were not rewritten to use the socket VPN layer will go out into the network unencrypted.

In certain embodiments the VPN core activity instructions on a device are modified to receive data to and from sockets instead of from a conventional TUN/TAP driver. This may include establishing a socket VPN layer.

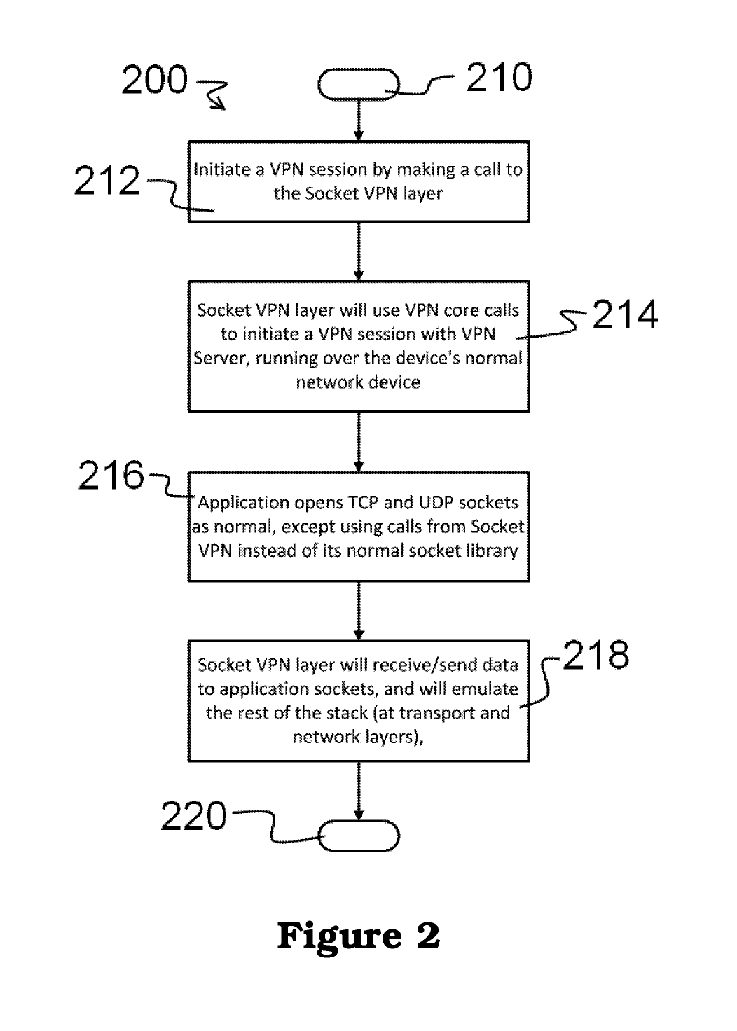

FIG. 2 illustrates a method 200 which may be employed in certain embodiments.

The method of FIG. 2 begins at a flow label 210.

At a step 212 an application initiates a VPN session by making a call to a socket VPN layer.

At a step 214 the Socket VPN layer will use VPN core calls to initiate a VPN session with a VPN server. This VPN session will operate over the device's normal network device.

At a step 216 the application opens TCP and UDP sockets using conventional techniques for other socket operations, except it will use calls from a socket VPN instead of its normal socket library.

At a step 218 socket VPN layer will send and receive data to application sockets, and will emulate the rest of the stack at the transport and network layers by sending data out to the VPN server and relaying incoming data as well. In operation, the VPN server thinks it is talking to a normal VPN client endpoint using the IP address of the client device.

At a step 220 the method ends. The end of the method may occur when the application exits and shuts down VPN session.

### VPN Client Layer Operation

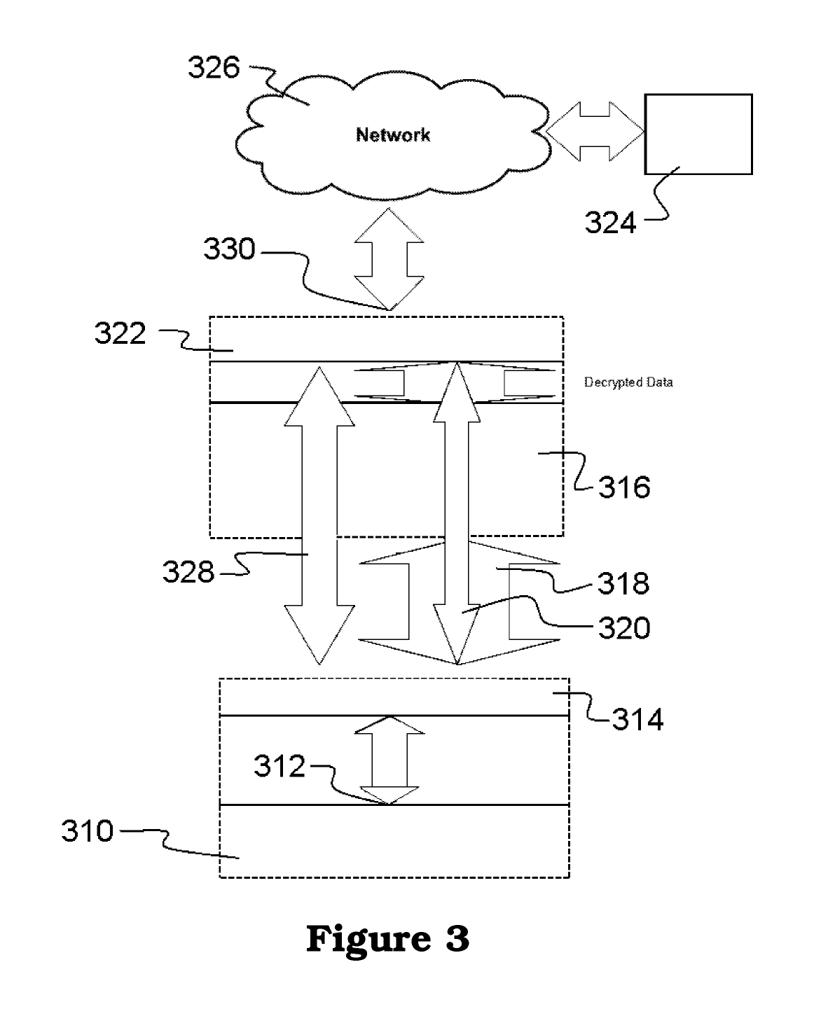

FIG. 3 depicts an embodiment of one possible implementation of a virtual private network socket. In FIG. 3 and application 310 running on a VPN client establishes a socket VPN connection for an application port 312 using a socket VPN client layer 314. Establishing the socket connection may include one or more of the following:
server IP address of a VPN host server;
server port of VPN host server;
protocol to use(UDP/TCP/etc);
proxy method and proxy host:port (if needed), and
miscellaneous settings such as encryption method, compression and other parameters.

Once a connection is established the socket VPN client layer 314 initiates a connection with a VPN server 316. The connection may be established a private tunnel 318 for encapsulating encrypted information contained in the virtual stream 320.

The socket VPN layer may receive from the VPN server 316 one or more of the following:
VPN server control channel IP and port (which may be different from VPN public IP address);
VPN public IP address;
VPN internal IP address, network, and netmask;
Client Session Key (unique to each session), and
all encryption keys/certificates required for secure VPN connection.

In operation the socket VPN client layer 314 emulates a VPN client. In some embodiments it does not configure a local interface as it does not need to redirect any local traffic to itself other the sockets opened using Socket VPN. For example and without limitation, these embodiments would not use a TUN/Tap device. Rather, it may receive incoming VPN stream data and emulate the TCP stack, pretending to be a local interface from the point of view of the VPN server 316.

In some embodiments a secure client socket may be initialized using one or more of the following elements:

```
      1. Application initiates vpns_socket( ) call (functionally equivalent to socket( )
from sys/socket.h)
            vs = vpns_socket(int domain, int type, int protocol),
      where:
          - Domain is the address family (AF_INET (IP), AF_INET6, etc).
          - type is type of service (SOCK_STREAM, SOCK_DGRAM, SOCK_RAW), and
          - protocol is specific protocol (in this example, TCP). Depending on address
      family and VPN implementation, some domain or types may not be available.
      2.  Application names (assigns transport address to) vpnsocket:
            vpns_bind(int socket, const struct sockaddr *address, socklen_t
      address_len),
      where:
          - socket is the socket created with the initial vpns_socket call.
          - Sockaddr has the same format as the standard bind( ) call, where:
          struct sockaddr_in
            {
            _uint8_t sin_len;
            sa_family_t sin_family;
            in_port_t sin_port;
            struct in_addr sin_addr;
            char  sin_zero[8];
            };
          - sin_family - same family used as domain in intial vpn_socket call;
          - sin_port - target port number, and
          - sin_addr - address for socket (local, usually INADDR_ANY to bind to all
          sockets).
```

In operation, instead of binding to a local interface, binding the socket to the VPN internal IP address (which is physically located on the external interface of the remote VPN server) is effectuated. In some embodiments a duplicate of the interface structure is maintained internally in the Socket VPN client layer 314.

One having skill in the art will recognize that the code samples and procedures detailed herein are merely to illustrate by way of example and should not be construed to be limiting in any way. Accordingly, in some embodiments the port mapping described herein may not be the same local port therefore allowing multiple clients on the same VPN server to use the same local port. However, in some embodiments the VPN layer must retain this port mapping relationship for operational use. For example and without limitation, if a client desires to use port 5444, but in reality data is leaving the Socket VPN server layer from port 14121. Replies to port 14121 may then also be remapped back to port 5444 at the Socket VPN client layer 314. One having skill in the art will appreciate that standard Netfilter masquerading or port forwarding functions may be inapplicable for this mapping.

At this point in the operation, the Socket VPN client layer 314 has re-created a virtual transport/network layer stack identical to that present on the remote VPN server 316 wherein a corresponding Socket VPN Server layer 322 exists. One having skill in the art will note that there is no actual external interface on the Socket VPN client layer and no corresponding internal interface on the Socket VPN server layer.

### Connecting to a Remote Server

Connection to a remote server may be effectuated using a function call such as:

int vpns_connect(int socket, const struct sockaddr *address, socklen_t address_len); where:
socket is the socket created with the initial vpns_socket call, and
sockaddr has the same format as a standard connect( ) call (for example i.e. same format as bind( ) above).

For example and without limitation, to open an http socket to a network computer such as www.webserver.com on port 80, first set up vpns_{—socket( ) vpns}_bind( ), then setup a sockaddr struct with sin_port=80 and sin_addr=resolved IP address of www.webserver.com, finally call vpns_connect( ). This will initiate a socket connection on the far side of the VPN server 322 (external address) connecting to the remote target server 324 through the network 326. By way of example only, the VPN server 322 initiates a socket connection to www.webserver.com port 80 from it's own external port 330.

In operation, all functions executed by the local VPN client layer 314 stack are also executed by the remote VPN server layer 322 stack as well. These functions may be relayed through a separate control channel 328 maintained between Socket VPN client layer 314 to Socket VPN server layer 322. This sets up a virtual stream through the VPN, from Socket VPN client layer 314 to Socket VPN server layer 322, that relays all data unchanged from internal virtual socket on Socket VPN client layer 314 to internal virtual socket on Socket VPN server layer 322. One having skill in the art will appreciate that from the perspective of the VPN, this virtual stream is similar to other network data sent through it.

In some embodiments any error handling or configuration on a live virtual stream is done through the control channel 328 as well.

### System Operation

Some embodiments may include operations to remote servers other than a VPN server. By way of example only, an application may send data through the remapped socket as apparent read( ) and write( ) system calls. Data going into the local vpns_socket( ) may be encapsulated and transparently encrypted and/or compressed by the VPN layer using whatever VPN protocol stream is preferred, and transmitted over the Internet. The data is received and decapsulated at the VPN server side, where the Socket VPN server layer maps the outgoing data stream to the outgoing interface and port that was bound earlier using vpns_bind( ). From this outgoing interface and port, it goes out over the network to the target server specified in vpns_{—connect( ).}

### Socket Listener

In some embodiments an application may perform listening on a particular socket. To effectuate listening, methods and procedures disclosed herein may be used on incoming connections. However certain embodiments may be limited to operation with services that employ arbitrary socket numbers instead of well-known socket numbers owing to public-facing server side mapping of incoming traffic to more than one receiving listener at a time.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

1-2. (canceled)

3. One or more processor readable storage devices having non-transitory processor readable code embodied on said processor readable storage devices, said processor readable code for programming one or more processors to:
effectuate a TCP/IP stack, said stack operative to send and receive data, said stack further including a VPN layer operative to communicate with a VPN on one or more application ports.

4. The device of claim 3 wherein said processor instructions further include instructions to bind the stack to an internal IP address.

5. The device of claim 3 wherein the VPN layer is further operative to communicate on a single application port without binding any other ports to the VPN layer.

6. The device of claim 3 wherein the VPN layer is further operable to map multiple remote VPN clients to the same local port.

7. The device of claim 3 wherein said communicate includes encryption of data being communicated.

8. A method including:
effectuating a TCP/IP socket on a communications device;
effectuating a VPN layer on said socket, said VPN layer operable to communicate using a private tunnel, and
using VPN core calls to initiate a session with a remote server.

9. The method of claim 8 wherein said VPN layer is operable to communicate on a single application port without binding any other ports to the VPN layer.

10. The method of claim 8 wherein said method further includes binding the socket to an internal IP address.

11. The method of claim 8 wherein the VPN layer is further operable to map multiple remote VPN clients to the same local port.

12. The method of claim 8 further includes encrypting of data being communicated.

13. A device including:
at least one communications port;
a TCP/IP stack coupled to said port, said stack operable to effectuate a socket;
wherein said stack is further operable to bind a single port on the device without binding other ports, and
communicate with a remote device using secure communications.

14. The device of claim 13 wherein the secure communication includes data encryption.

15. The device of claim 13 wherein the secure communications include a virtual private network.

16. The device of claim 13 wherein said stack is further operable to bind the socket to an internal IP address.

17. The device of claim 13 wherein the VPN layer is further operable to map multiple remote VPN clients to the same local port.
